(19) United States
(12) Patent Application Publication
(10) Pub. No.: US 2008/0271069 A1
(43) Pub. Date: Oct. 30, 2008

(54) System and Method for the Provision of Advertisement Coupled to Treatment of Video on Demand Through Set Top Box

(75) Inventors: Young Min Kim, Seoul (KR); Gyung Sueng Yang, Seoul (KR); Young Ick Kim, Gwangju (KR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: HANAROMEDIA CO., LTD., Seoul (KR)

(21) Appl. No.: 12/088,346

(22) PCT Filed: Oct. 21, 2005
(86) PCT No.: PCT/KR2005/003510

§ 371 Date: Mar. 27, 2008

(30) Foreign Application Priority Data
Sep. 29, 2005 (KR) 10-2005-0091033

(51) Int. Cl. H04N 7/025; H04N 7/173

(52) U.S. Cl. 725/32; 725/87

(57) ABSTRACT

The present invention relates to a system and method for providing advertisement at a set top box in connection with processing of video-on-demand (VOD) contents. The system for providing advertisement at a set top box in connection with VOD contents, comprises: a VOD server for providing VOD contents; an advertisement server for providing advertisement data; and a set top box for processing the VOD contents from the VOD server and the advertisement data from the advertisement server to display the VOD contents and the advertisement data on a user's television, wherein the set top box includes: an input/output unit for performing input and output of data transmitted to the set top box; a VOD management application for receiving and processing information of VOD contents orderable for a user, a user interface for expressing the information and an order of the user; a cache memory for buffering the ordered VOD contents; a storage for storing the advertisement data from the advertisement server; an advertisement-data management application for managing the advertisement data; and a buffering monitoring scheduler for monitoring status of buffering VOD contents at the cache memory and controlling the advertisement management application to process the advertisement data during the buffering based on the monitoring result. By implementing the present invention, the advertisement data can be efficiently utilized through a set top box in connection with display of VOD contents.

### TECHNICAL FIELD

The present invention generally relates to a system and method for providing advertisement at a set top box in connection with processing of video-on-demand (VOD) contents, and more particularly to a system and method for efficiently providing advertisement data in connection with processing of VOD contents when said contents are provided to a user through a set top box.

### BACKGROUND ART

Digital broadcasting is rapidly becoming common and standardized. Various technical developments are evolving in a number of areas, e.g., digital signal transmission through a broadcasting network, data multiplexing, video and audio signal processing, digital television display and the like. Compared to analog broadcasting, the digital broadcasting can compress informational data for processing. Further, the digital broadcasting has a high transmission speed and provides superior quality of audio and video compared to analog broadcasting. Moreover, unlike the conventional analog broadcasting, the digital broadcasting is advantageous since it can efficiently utilize frequency due to digital modulation. Therefore, it can broadcast a variety of information through hundreds of channels, which users can access through televisions.

Among others, the digital broadcasting can implement an interactive television by data broadcasting. Using the interactive television, the users can interact with the television, in addition to controlling the channel, volume and video tapes. Thus, the users can perform various operations such as payment, banking, shopping, reservation, games, forum discussion and the like. Moreover, there has recently been an increasing interest in ordering and watching video-on-demand (VOD) contents through the digital broadcasting, as shown in U.S. Pat. Nos. 4,506,387, 4,890,320, 4,995,078, 5,063,610, 5,206,722 and 5,253,275.

### DISCLOSURE OF INVENTION

### Technical Problem

It is an object of the present invention to provide a system and method for efficiently providing advertisement data in connection with a VOD service through the digital broadcasting. Particularly, in addition to implementing a VOD service through a set top box that deals with digital broadcasting signals, it is an object of the present invention to provide a system and method capable of efficiently providing advertisement data through the set top box in connection with the VOD service.

### Technical Solution

In accordance with a preferred embodiment of the present invention, there is provided a system for providing advertisement at a set top box in connection with processing of video-on-demand (VOD) contents, comprising: A) a VOD server for providing VOD contents; B) an advertisement server for providing the advertisement data; and C) a set top box for processing the VOD contents from the VOD server and the advertisement data from the advertisement server to display the VOD contents and the advertisement data on a user's television, wherein the set top box includes: C-1) an input/output unit for performing input and output of data transmitted to the set top box; C-2) a VOD management application for receiving and processing information of VOD contents orderable for a user, a user interface for expressing the information, and an order of the user; C-3) a cache memory for buffering the ordered VOD contents; C-4) a storage for storing the advertisement data from the advertisement server; C-5) an advertisement-data management application for managing the advertisement data; and C-6) a buffering monitoring scheduler for monitoring status of buffering VOD contents at the cache memory and controlling the advertisement management application to process the advertisement data during the buffering based on the monitoring result.

In accordance with another preferred embodiment of the present invention, there is provided a method for providing advertisement at a set top box in connection with processing of video-on-demand (VOD) contents, comprising: a) using a VOD management application to display information of VOD contents orderable for a user on a user's television; b) when an order for particular VOD contents is received from the user, requesting the ordered VOD contents to a VOD server and receiving the ordered VOD contents delivered as a streaming data; c) buffering the VOD data delivered from the VOD server at a cache memory; d) using a buffering monitoring scheduler to monitor buffering status of the VOD data at the cache memory; and e) delivering a result of the monitoring to the advertisement-data management application and displaying advertisement data stored in a storage based on the monitoring result.

### ADVANTAGEOUS EFFECTS

A system and method for providing advertisement at a set top box in connection with processing of VOD contents in accordance with the present invention provides the following advantages.

(1) First, the system and method for providing advertisement at a set top box in connection with processing of VOD contents in accordance with the present invention displays the advertisement while a user waits for watching the VOD contents. This allows the advertisement to be provided without disturbing the user in watching at all.

(2) Second, the system and method for providing advertisement at a set top box in connection with processing of VOD contents in accordance with the present invention includes a complementary combination of a VOD management application, an advertisement-data management application and a buffering monitoring scheduler. By virtue of the complementary combination, the system and method efficiently detects buffering status. Then, based on a complementary combination of monitoring the result of the buffering status and data managed by the advertisement-data management application, the system and method optimally provides advertisement to a user for the monitoring result. For example, in selecting advertisement data stored in a storage, the system and method may give priority to advertisement that can be displayed for a time duration corresponding to the time required for the buffering, and which is related to the VOD contents selected by the user.

(3) Third, by virtue of an advertisement-data management application, the system and method may efficiently manage advertisement data stored in a storage. This allows the advertisement data to be managed based on the capacity of the storage.

### BRIEF DESCRIPTION OF THE DRAWINGS

FIG. 1 is a block diagram showing a preferred embodiment of a system for providing advertisement at a set top box in connection with processing of VOD contents, which is in accordance with the present invention.

FIG. 2 shows data managed by an advertisement-data management application in accordance with a preferred embodiment of the present invention.

FIG. 3 shows a result of monitoring by the buffering monitoring scheduler in accordance with the present invention.

FIG. 4 is a flowchart showing the provision of advertisement data by a system for providing advertisement at a set top box in connection with processing of VOD contents, which is in accordance with the present invention.

FIG. 5 shows a preferred embodiment of a user interface displayed to a user by the VOD management application.

### MODE FOR THE INVENTION

Hereinafter, the present invention will be described in more detail with reference to the accompanying drawings.

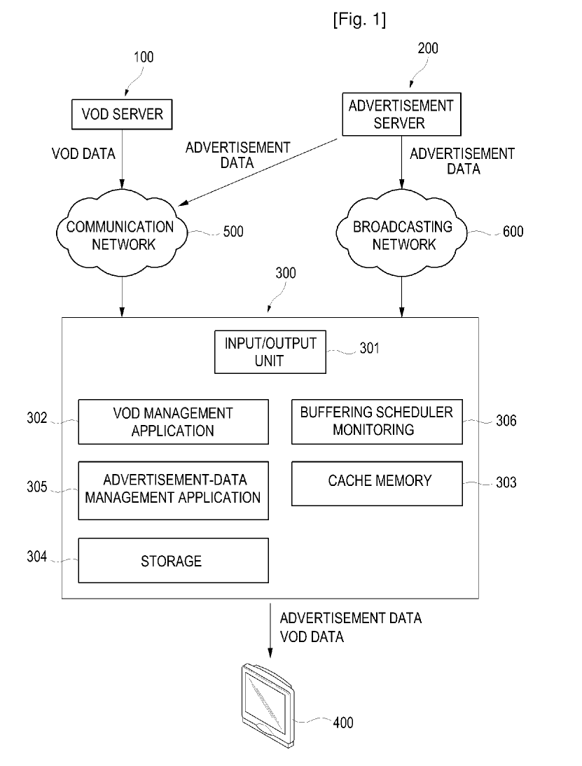

FIG. 1 is a block diagram showing a preferred embodiment of a system for providing advertisement at a set top box in connection with processing of VOD contents, which is in accordance with the present invention. As shown in FIG. 1, the system 1 for providing advertisement at a set top box in connection with processing of VOD contents in accordance with the present invention includes a VOD server 100, an advertisement server 200, a set top box 300 and a user's television 400.

The VOD server 100 delivers VOD contents to the set top box 300. Preferably, the VOD contents are delivered from the VOD server 100 to the set top box 300 through a return path using a communication network 500.

The advertisement server 200 delivers advertisement data to the set top box 300. The advertisement data is not necessarily delivered through the return path, but may also be delivered through a broadcasting network. Consequently, the advertisement data may be delivered through the communication network 500 or a broadcasting network 600. Preferably, the advertisement data is delivered through the broadcasting network 600. It is preferable that the delivery of the advertisement data from the advertisement server 200 is carried out by the advertisement server 200 itself, and not by a user's request. This implies that the advertisement data may be delivered to the set top box 300 by pushing from the advertisement server 200 at regular intervals, or at irregular intervals after receiving the user's advertisement-data watching information.

The set top box 300 includes an input/output unit 301, a VOD management application 302, a cache memory 303, a storage 304, an advertisement-data management application and a buffering monitoring scheduler 306. The input/output unit 301 serves to receive VOD data and advertisement data, as well as an ordinary broadcasting signal. The input/output unit 301 also serves to provide a user with information provided by the VOD server 100 and the advertisement server 200. The cache memory 303 performs buffering of the VOD data delivered to the set top box 300. The storage 304 keeps the advertisement data delivered from the advertisement server 200.

In accordance with the present invention, the set top box 300 may further include a VOD management application 302, an advertisement-data management application 305 and a buffering monitoring scheduler 306. The VOD management application 302 serves to provide a user with information for orderable VOD contents as well as a user interface to express the information. It also serves to receive and process the user's order.

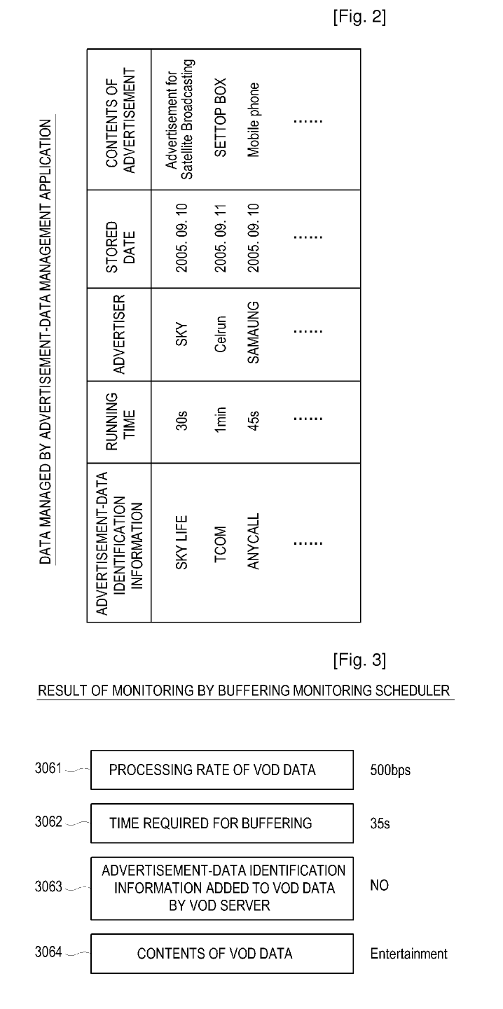

The advertisement-data management application 306 manages advertisement data. At least, it manages identification information and running time of the advertisement data stored in the storage 304. In addition to such information, it may further manage contents, priority, advertiser and/or stored date of the advertisement. FIG. 2 shows the data managed by the advertisement-data management application in accordance with a preferred embodiment of the present invention.

The buffering monitoring scheduler 306 monitors buffering status of VOD contents at the cache memory 303 and delivers the monitoring result to the advertisement-data management application 305. Based on the monitoring result, the advertisement-data management application 306 selects advertisement data to be displayed during the buffering time and delivers it to the user's television 400 to display the selected advertisement data. When the buffering at the cache memory 303 is completed and the VOD contents is ready to be played, the buffering monitoring scheduler 306 stops the processing of the advertisement data and processes the VOD contents to display it on the user's television 400. Accordingly, without disturbing the user in watching the VOD contents, the advertisement data can be provided efficiently. In accordance with the present invention, the buffering monitoring scheduler 306 is used to monitor the buffering status of the VOD data. Based on the monitoring result, a piece of advertisement data or a set of two or more pieces of advertisement data, which corresponds to the required time, is provided. In addition, with the advertisement-data management application 305, the present invention can select and display advertisement data contents of those corresponding to the VOD data, or advertisement data of an advertiser who is the supplier of the VOD data.

In accordance with a system for providing advertisement at a set top box in connection with processing of VOD contents of the present invention, the delivery of the VOD contents from the VOD server 100 is performed by a user's request. Accordingly, the VOD data is delivered to the set top box 300 in real time and in a streaming format. In contrast, the advertisement data from the advertisement server 200 is not delivered in real time. Rather, it is delivered in advance from the advertisement server 200 to the set top box 300 and then stored in advance in the storage 304 of the set top box 300. Here, it is preferable to delete the advertisement data displayed on the user's television 400. This is performed by the advertisement-data management application 305. The advertisement-data management application 305 may deliver the identification information of the deleted advertisement data to the advertisement server 200. By doing so, the advertisement server 200 may determine what advertisement data exist in the set top box 300 and provides new advertisement data based on the determination result. In addition to deleting the displayed advertisement data, it is preferable to delete the advertisement data regularly. Based on the stored date, the advertisement-data application 305 may delete advertisement data in force when predetermined time duration (e.g., 15 days) has elapsed from its stored date. By doing so, an efficient utilization of the storage 304 can be secured and the advertisement server 200 can perform regular updates.

Further, in accordance with a preferred embodiment of the present invention, the VOD data from the VOD server 100 may be transmitted together with the identification information of the advertisement data to be displayed while the VOD data is being buffered. This allows for the VOD server 200 to select the advertisement data when it provides the VOD contents to a user. In such a case, the buffering monitoring scheduler 306 of the set top box 300 refers to the advertisement-data management application 305 to determine whether the storage 304 has the advertisement data that corresponds to the advertisement-data identification information received together with the VOD data. If the corresponding advertisement data exists, then the buffering monitoring scheduler 306 displays the corresponding advertisement data during the buffering. If the corresponding advertisement data does not exist, then the advertisement-data identification information received from the VOD server 100 is disregarded. FIG. 3 shows a result of monitoring by the buffering monitoring scheduler 306 in accordance with the present invention. As shown in FIG. 3, the monitoring may result in a processing rate 3061 of the VOD data currently being displayed, time duration 3062 required for the buffering, existence 3063 of advertisement-data identification information added to the VOD data by the VOD server 200, contents 3064 of the VOD data and the like. Based on the monitoring result, the advertisement-data management application selects appropriate advertisement data, which is displayed on the user's television 400.

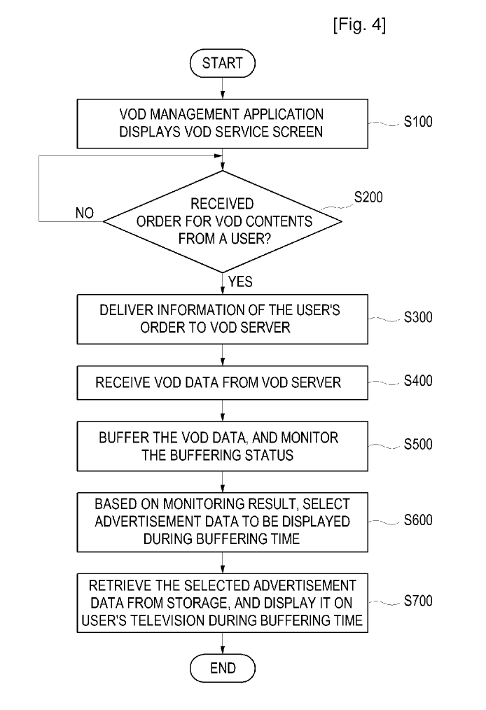

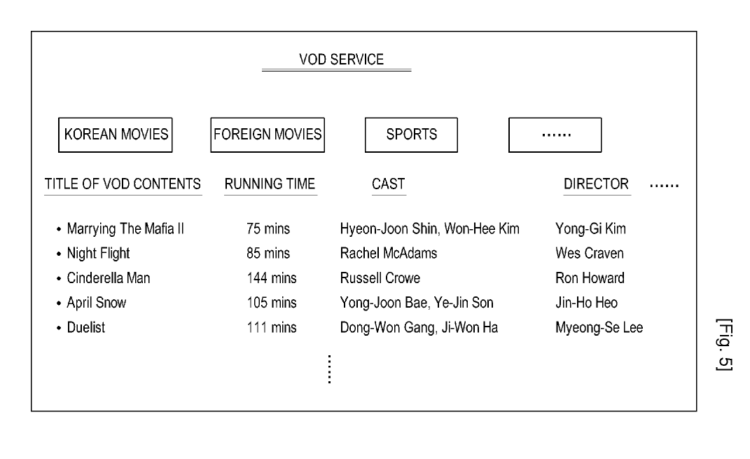

FIG. 4 is a flowchart showing the provision of advertisement data by a system for providing advertisement at a set top box in connection with processing of VOD contents, which is in accordance with the present invention. First, a VOD management application is used to display a VOD service screen, which includes basic information of VOD contents orderable for a user, on the user's television (S100). FIG. 5 shows a preferred embodiment of a user interface displayed to the user by the VOD management application. As shown in FIG. 5, the user is provided with data such as the title, running time, cast, director and the like of the orderable VOD contents. The user may select desired VOD contents from the screen. When an order for particular VOD contents is received from the user (S200), information of the user's order is delivered to the VOD server (S300) and the ordered VOD contents is received as streaming data (S400). Here, the delivery of the VOD contents from the VOD server is performed in response to a user's request. Therefore, the VOD data is delivered to the set top box in real time and in a streaming format. The VOD data delivered from the VOD server is buffered at a cache memory (S500). Here, with regard to the buffering at the cache memory, the buffering status is monitored by the buffering monitoring scheduler (S400). As a result of the monitoring, there can be obtained a processing rate 3061 of the VOD data currently being displayed, time duration 3062 required for buffering, existence 3063 of advertisement-data identification information added to the VOD data by the VOD server 200, contents 3064 of the VOD data and the like, as shown in FIG. 3. Based on the monitoring result, the advertisement-data management application is referred to select advertisement data to be displayed during the buffering time (S600). The selected advertisement data is retrieved from a storage and displayed on a user's television during the buffering time (S700). As mentioned above, the advertisement data is not delivered in real time, but is rather delivered to the set top box in advance to be stored.

1. A system for providing advertisement at a set top box in connection with processing of video-on-demand (VOD) contents, comprising:
A) a VOD server for providing VOD contents;
B) an advertisement server for providing advertisement data; and
C) a set top box for processing the VOD contents from the VOD server and the advertisement data from the advertisement server so as to display the VOD contents and the advertisement data on a user's television,
wherein the set top box includes:
C-1) an input/output unit for performing input and output of data transmitted to the set top box;
C-2) a VOD management application for receiving and processing information of VOD contents orderable for a user, a user interface for expressing the information and an order of the user;
C-3) a cache memory for buffering the ordered VOD contents;
C-4) a storage for storing the advertisement data from the advertisement server;
C-5) an advertisement-data management application for managing the advertisement data; and
C-6) a buffering monitoring scheduler for monitoring status of buffering VOD contents at the cache memory and controlling the advertisement management application to process the advertisement data during the buffering based on the monitoring result.

2. The system of claim 1, wherein the VOD server is connected to the set top box through a communication network.

3. The system of claim 1, wherein the advertisement server is connected to the set top box through a broadcasting network or a communication network.

4. The system of claim 1, wherein the advertisement-data management application deletes the corresponding advertisement data together with delivering to the advertisement server identification information of advertisement data displayed to the user.

5. A method of providing advertisement at a set top box in connection with processing of video-on-demand (VOD) contents, comprising:
a) using a VOD management application to display information of VOD contents orderable for a user on a user's television;
b) when an order for particular VOD contents is received from the user, requesting the ordered VOD contents to a VOD server and receiving the ordered VOD contents delivered as a streaming data;
c) buffering the VOD data delivered from the VOD server at a cache memory;
d) using a buffering monitoring scheduler to monitor buffering status of the VOD data at the cache memory; and
e) delivering a result of the monitoring to the advertisement-data management application and displaying advertisement data stored in a storage based on the monitoring result.

6. The method of claim 5, wherein the VOD data is delivered from the VOD server to the set top box through a return path in response to a user's request and the advertisement data is pushed from the advertisement server without regard to the user's request.

7. The method of claim 5, wherein identification information of advertisement data displayed to the user is delivered to the advertisement server.

8. The method of claim 7, wherein the advertisement data displayed to the user is deleted by the advertisement-data management application.

9. A set top box capable of displaying advertisement data in connection with processing of video-on-demand (VOD) contents, comprising:
an input/output unit for performing input and output of data;
a VOD management application for receiving and processing information of VOD contents orderable for a user, a user interface for expressing the information and an order of the user;
a cache memory for buffering the ordered VOD contents;
a storage for storing the advertisement data from the advertisement server;
an advertisement-data management application for managing the advertisement data; and
a buffering monitoring scheduler for monitoring status of buffering VOD contents at the cache memory and controlling the advertisement management application to process the advertisement data during the buffering based on the monitoring result.
